(19) United States
(12) Patent Application Publication
(10) Pub. No.: US 2014/0222915 A1
(43) Pub. Date: Aug. 7, 2014

(54) SNS CONTENTS INTEGRATED MANAGEMENT METHOD AND TERMINAL FOR A PLURALITY OF SNS CHANNELS

(71) Applicant: LG ELECTRONICS INC., Seoul (KR)

(72) Inventor: Hyeongseok ROH, Seoul (KR)

(73) Assignee: LG ELECTRONICS INC., Seoul (KR)

(21) Appl. No.: 13/869,805

(22) Filed: Apr. 24, 2013

(30) Foreign Application Priority Data
Feb. 6, 2013 (KR) 10-2013-0013365

(51) Int. Cl. H04L 29/06

(52) U.S. Cl. CPC H04L 65/40
USPC 709/204

(57) ABSTRACT

Provided is a terminal. A terminal includes: a memory storing media contents uploadable into a plurality of SNS channels; and a control unit updating arbitrary media contents stored in the memory into the plurality of SNS channels, categorizing each media contents and information on each SNS channel into which corresponding media contents are uploaded and integrally managing the categorized media contents and information, writing a comment on an SNS channel into which each corresponding media contents are uploaded by each media contents on a designated menu screen, and displaying a response to corresponding media contents.

### CROSS-REFERENCE TO RELATED APPLICATIONS

The present application claims priority under 35 U.S.C. 119 and 35 U.S.C. 365 to Korean Patent Application No. 10-2013-0013365 (filed on Feb. 6, 2013), which is hereby incorporated by reference in its entirety.

### BACKGROUND

The present disclosure relates to a social network system (SNS) contents integrated management method and terminal for a plurality of SNS channels, and more particularly, to an SNS contents integrated management method and terminal for a plurality of SNS channels, in which contents or comments uploaded using several SNS channels are categorized by each SNS, each user, or each contents in a background screen or a gallery for each thread and are managed, and without executing an individual SNS application, a comment is written in real-time or a response thereto is displayed in real-time.

Terminals may be classified into mobile/portable terminals and stationary terminals according to portability. Then, the portable terminals may be classified into handheld terminals and vehicle mount terminals according to whether users can carry terminals personally.

As such terminals are becoming diversified in functions, they are realized in the forms of multimedia players having complex functions for capturing pictures or videos, playing music or movie files, playing games, or receiving broadcastings in addition to communication functions such as voices, texts, images and e-mails.

In order to support and enhance the functions of such terminals, improving a structural part and/or a software part of a terminal may be considered.

As a social network system (SNS) channel is developed, various SNS channels are introduced. For example, the SNS channel may include Twitter, Facebook, LinkedIn, and LINE. Users may access each SNS channel to post an article or write a comment on a posted article by using each SNS application installed in mobile terminals. Moreover, users may access each SNS channel to share various contents via an SNS channel through a series of operations for uploading or downloading various contents.

In the past, inconveniently, users operating several SNS channels run each SNS application to access each SNS channel, and then, upload or read contents, or post or read a comment.

In addition, even if a comment is posted on the contents uploaded by a user after a long time elapses, since the user cannot confirm a corresponding comment in real-time, the posted comment is neglected.

### SUMMARY

Embodiments provide an SNS contents integrated management method and terminal for a plurality of SNS channels, in which contents or comments uploaded using several SNS channels are categorized by each SNS, each user, or each contents in a background screen or a gallery for each thread and are managed, and without executing an individual SNS application, a comment is written in real-time or a response thereto is displayed in real-time.

In one embodiment, a terminal includes: a memory storing media contents uploadable into a plurality of SNS channels; and a control unit updating arbitrary media contents stored in the memory into the plurality of SNS channels, categorizing each media contents and information on each SNS channel into which corresponding media contents are uploaded and integrally managing the categorized media contents and information, writing a comment on an SNS channel into which each corresponding media contents are uploaded by each media contents on a designated menu screen, and displaying a response to corresponding media contents.

The control unit may categorize the media contents uploaded into the plurality of SNS channels by each SNS, each user, or each media contents in a background or a gallery screen by a thread of each SNS channel, and may manage and display the categorized media contents.

The control unit may display a real-time comment on the media contents uploaded into the SNS channel and a response to the media contents or the comment, on a screen in real-time.

The control unit may store media contents selected from media SNS contents uploaded into the plurality of SNS channels and SNS contents added to corresponding media contents in the memory and may manage the stored media contents and SNS contents.

The control unit may perform a real-time monitoring or a real-time update on the stored media contents and SNS contents.

The control unit may register in a predetermined menu screen an object for displaying a thread of a corresponding SNS channel into which the media contents are uploaded in order for the real-time monitoring or the real-time update, and may display the registered object.

The control unit may display the object for displaying the thread of the SNS channel as a thumbnail on a background screen.

The control unit may maximize corresponding media contents and may display the maximized corresponding media contents on a background screen once the thumbnail is clicked.

The control unit may display information on a thread host uploading corresponding media contents and at least one information on a thread guest generating a comment on corresponding media contents, on the background screen.

The thread host information and the at last one thread guest information may include a speech bubble displaying a comment generated on a corresponding thread.

The control unit may execute a comment input mode on a corresponding speech bubble once the speech bubble is clicked.

The control unit may attempt to make a contact to a connect number linked to corresponding thread guest information once the thread guest information is clicked.

The control unit may attempt to make a phone call on the basis of the contact number.

The control unit may move and displays the at least one thread guest information displayed on the background screen in correspondence to a left and right flicking input.

The control unit may register a plurality of objects for displaying threads of each SNS channel into which the media contents are uploaded by each SNS channel, in a predetermined menu screen and may display the registered objects.

The control unit may add to the object a plurality of identification information displaying each SNS channel into which corresponding media contents are uploaded and displays the object.

The control unit may display a thread of a corresponding SNS channel once one of the plurality of identification information is clicked.

In another embodiment, an SNS contents integrated management method for a plurality of SNS channels includes: storing media contents uploadable to a plurality of SNS channels in the memory; uploading arbitrary media contents stored in the memory into the plurality of SNS channels; categorizing each media contents and each SNS channel information into which corresponding media contents are uploaded and integrally managing the categorized media contents and SNS channel information; and writing a comment on an SNS channel into which corresponding media contents are uploaded by each media contents on a designated menu screen, and displaying a response to corresponding media contents.

The method may further include storing media contents selected from media contents uploaded into the plurality of SNS channels and SNS contents added to corresponding media contents in the memory and managing the media contents and SNS contents.

The method may further include performing a real-time monitoring on the stored media contents and SNS contents.

The details of one or more embodiments are set forth in the accompanying drawings and the description below. Other features will be apparent from the description and drawings, and from the claims.

### BRIEF DESCRIPTION OF THE DRAWINGS

FIG. 1 is a block diagram illustrating an SNS contents integrated management method for a plurality of SNS channels according to an embodiment of the present invention.

FIG. 2 is a flowchart illustrating an SNS contents integrated management method for a plurality of SNS channels according to an embodiment of the present invention.

FIGS. 3 to 10 are screen views illustrating an SNS contents integrated management method for a plurality of SNS channels according to an embodiment of the present invention.

FIG. 11 is a view illustrating an SNS contents integrated management method for a plurality of SNS channels according to another embodiment of the present invention.

FIG. 12 is a screen view illustrating an SNS contents integrated management method for a plurality of SNS channels according to another embodiment of the present invention.

FIGS. 13 and 14 are screen views illustrating an SNS contents integrated management method for a plurality of SNS channels according to another embodiment of the present invention.

FIG. 15 is a screen view illustrating an SNS contents integrated management method for a plurality of SNS channels according to another embodiment of the present invention.

FIGS. 16 to 18 are screen views illustrating an SNS contents integrated management method for a plurality of SNS channels according to another embodiment of the present invention.

### DETAILED DESCRIPTION OF THE EMBODIMENTS

Hereinafter, preferred embodiments will be described in more detail with reference to the accompanying drawings. The following introduced embodiments are provided as examples to sufficiently deliver the idea of the present invention to one of ordinary skill in the art. The invention may, however, be embodied in many different forms and should not be construed as being limited to the embodiments set forth herein. Also, in the drawings, the width, length, and thickness of a component may be exaggerated for convenience of description. Like reference numerals refer to like elements throughout. The suffixes “module” and “unit” for components, which are used in the description below, are assigned and mixed in consideration of only the easiness in writing the specification. That is, the suffixes do not have different meanings or roles.

Mobile terminals described in this specification may include mobile phones, smart phones, pads, notebook computers, tablet PCs, laptop computers, digital broadcasting terminals, personal digital assistants (PDAs), portable multimedia players (PMPs), and navigation systems. However, it is apparent to one of ordinary skill in the art that configurations according to embodiments described in this specification may be applicable to stationary terminals such as digital TVs, desktop computers, etc. besides mobile terminals.

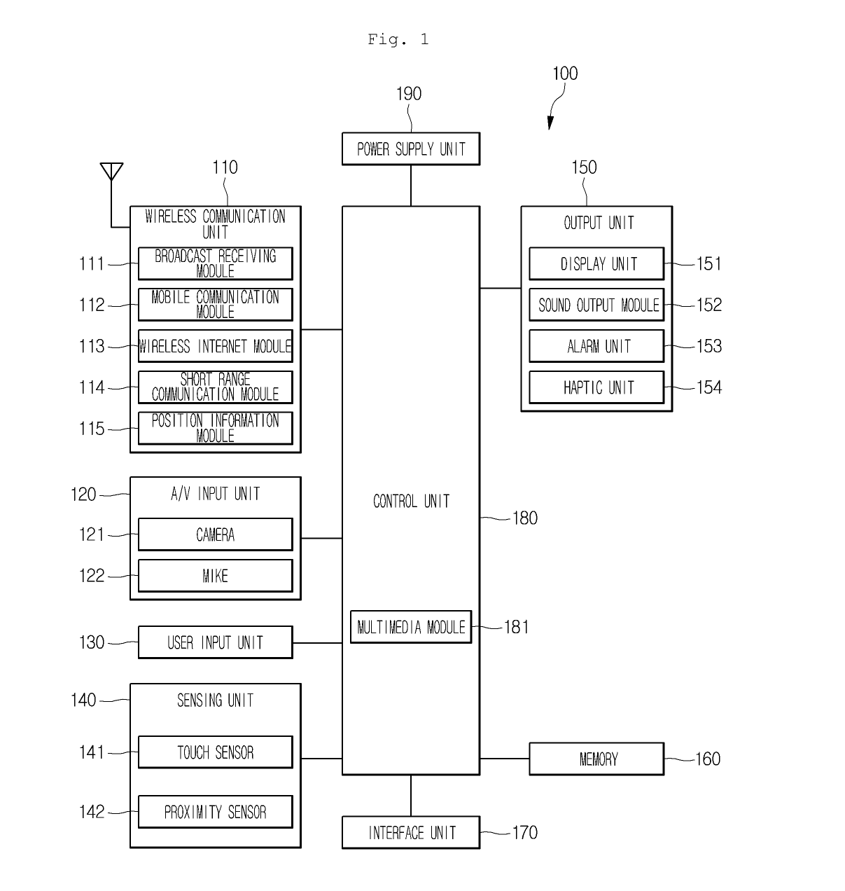

FIG. 1 is a block diagram illustrating an SNS contents integrated management method for a plurality of SNS channels according to an embodiment of the present invention.

Referring to FIG. 1, the mobile terminal 100 may include a wireless communication unit 110, an audio/video (A/V) input unit 120, a user input unit 130, a sensing unit 140, an output unit 150, a memory 160, an interface unit 170, a control unit 180, and a power supply unit 190. Since the components shown in FIG. 1 are not indispensable, a mobile terminal having more or less components may be realized.

The mobile terminal 100 may include a multi mode portable terminal accessing each communication network according to at least two communication methods or at least two mobile carriers and a multi standby portable terminal simultaneously accessing a communication network according to at least two communication methods or at least two mobile carriers.

Hereinafter, for convenience of description, a mobile terminal according to an embodiment of the present invention uses a multi standby mobile terminal as an example. The multi standby mobile terminal may simultaneously access three communication networks selected through a plurality of communication methods such as Code Division Multiple Access (CDMA), Global System for Mobile telecommunication (GSM), Wideband Code Division Multiple Access (WCDMA), and Wireless broadband (Wibro) or may simultaneously access three communication networks selected through a plurality of mobile carriers such as SKT, KTF, and LGT in the case of South Korea.

The wireless communication unit 110 may include at least one module for allowing wireless communication between the mobile terminal 100 and a wireless communication system or between the mobile terminal 100 and a network having the mobile terminal 100. For example, the wireless communication unit 110 may include a broadcasting receiving module 111, a mobile communication module 112, a wireless internet module 113, a short-range communication module 114, and a position information module 115.

The broadcasting receiving module 111 receives a broadcast signal and/or broadcast related information from an external broadcast management server through a broadcast channel. The broadcast channel may include a satellite channel and a terrestrial channel. The broadcast management server may refer to a server that generates and transmits a broadcast signal and/or broadcast related information or a server that receives a pre-generated broadcast signal and/or broadcast related information and transmits it to a terminal. The broadcast signal may include a combined broadcast signal of a TV or radio broadcast signal and a data broadcast signal, in addition to a TV broadcast signal, a radio broadcast signal, and a data broadcast signal.

The broadcast related information may refer to information relating to a broadcast channel, a broadcast program, or a broadcast service provider. The broadcast related information may be provided through a mobile communication network. In this case, the broadcast related information may be received by the mobile communication module 112. The broadcast related information may be in various formats. For example, the broadcast related information may include formats such as Electronic Program Guide (EPG) of Digital Multimedia Broadcasting (DMB) and Electronic Service Guide (ESG) of Digital Video Broadcast-Handheld (DVB-H).

The broadcast receiving module 111 may receive a digital broadcast signal by using digital broadcasting system such as Digital Multimedia Broadcasting-Terrestrial (DMB-T), Digital Multimedia Broadcasting-Satellite (DMB-S), Media Forward Link Only (MediaFLO), and Digital Video Broadcast-Handheld (DVB-H), Integrated Services Digital Broadcast-Terrestrial (ISDB-T). Of course, the broadcast receiving module 111 may be configured to fit other broadcasting systems in addition to the above-mentioned digital broadcasting system.

Broadcast signals and/or broadcast related information received through the broadcast receiving module 111 may be stored in the memory 160.

The mobile communication module 112 transmits/receives a wireless signal to/from at least one of a base station, an external terminal, and a server on a mobile communication network. Herein, the wireless signal may include various formats of data according to transmissions of voice call signals, video call signals or text/multimedia messages.

The wireless internet module 113, as a module for wireless internet access, may be internally or externally mounted on the mobile terminal 100. A wireless internet technique may include Wireless LAN (WLAN), Wireless Fidelity (Wi-Fi), Wireless broadband (Wibro), World Interoperability for Microwave Access (Wimax), and High Speed Downlink Packet Access (HSDPA).

The short-range communication module 114 refers to a module for short-range communication. A short range communication technique may include Bluetooth, Radio Frequency Identification (RFID), infrared Data Association (IrDA), Ultra Wideband (UWB), and ZigBee.

The position information module 115, as a module for obtaining the position of the mobile terminal 100, may include a global position system (GPS).

The A/V input unit 120, as a unit for inputting audio signals or video signals, may include a camera 121 and a mike 122. The camera 121 processes picture frames such as still images or videos obtained by an image sensor in a video call mode or a capture mode. The processed image frames may be displayed on a display unit 151.

The picture frames processed in the camera 121 may be stored in the memory 160 or may be transmitted to the outside through the wireless communication unit 110. The camera 121 may be provided at least two according to a usage environment.

The mike 122 receives external audio signals through a microphone in a call mode, a recording mode, or a voice recognition mode, and then, processes the received signals as electrical audio data. In the case of a call mode, the processed audio data are converted into transmittable formats, and then, outputted to a mobile communication base station through the mobile communication module 112. The mike 122 may have various noise cancelling algorithms to remove the noise occurring when external audio signals are received.

The user input unit 130 generates input data for allowing a user to control an operation of a terminal. The user input unit 130 may include a key pad, a dome switch, a touch pad (resistive/capacitive), a jog wheel, and a jog switch. The user input unit 130 may include an identification module selection switch generating a select signal for selecting an arbitrary identification module among a plurality of identification modules.

The sensing unit 140 senses current states of the mobile terminal 100 such as the open/close state of the mobile terminal 100, the position of the mobile terminal 100, user contacts, the orientation of the mobile terminal 100, and the acceleration/deceleration of the mobile terminal 100, so as to generate a sensing signal for controlling an operation of the mobile terminal 100. For example, when the mobile terminal 100 is a slide phone, whether the slide phone is opened or closed may be sensed. Additionally, the sensing unit 140 may sense whether the power supply unit 190 supplies power or whether the interface unit 170 is connected to an external device. For example, the sensing unit 140 may include a touch sensor 141 and a proximity sensor 142. The touch sensor 141 senses a touch operation. For example, the touch sensor 141 may have forms of a touch film, a touch sheet, and a touch pad.

The touch sensor 141 may have a mutual layer structure (hereinafter, referred to as a touch screen) with the display unit 151. The touch sensor may be configured to convert a pressure applied to a specific portion of the display unit 151 or a change in capacitance occurring at a specific portion of the display unit 151 into an electrical input signal.

The touch sensor 141 may be configured to sense a pressure when being touched in addition to a touched position and area.

When there is a touch input for the touch sensor 141, signals corresponding thereto are transmitted to a touch controller. The touch controller processes the signals and then transmits corresponding data to the control unit 180. By doing so, the control unit 180 determines which area of the display unit 151 is touched.

The proximity sensor 142 may be disposed inside a mobile terminal covered by a touch screen, or near a touch screen. The proximity sensor 141 refers to a sensor for detecting an object that approaches a predetermined detection surface or an object that is near the proximity sensor 141 by using electromagnetic force or infrared, without mechanical contact. The proximity sensor 141 has a longer lifecycle and higher availability than a contact type sensor.

Examples of the proximity sensor 142 may include a transmissive photoelectric sensor, a direct reflective photoelectric sensor, a mirror reflective photoelectric sensor, a high frequency oscillation proximity sensor, a capacitive proximity sensor, a magnetic proximity sensor, and an infrared proximity sensor. When a touch screen is capacitive, it is configured to detect the proximity of a pointer by using an electric field change due to pointer proximity. In this case, a touch screen (or a touch sensor) may be classified as a proximity sensor.

“proximity touch” refers to an action for allowing to recognize that a pointer is on a touch screen as the pointer is close on the touch screen without contacting. “contact touch” refers to an action that a pointer actually contacts on a touch screen. The position where a pointer makes proximity touch on a touch screen refers to the position where the pointer vertically corresponds to the touch screen when the pointer makes proximity touch.

The proximity sensor 142 detects proximity touch and proximity touch patterns (such as proximity touch distance, proximity touch direction, proximity touch speed, proximity touch time, proximity touch position, and proximity touch moving state). Information corresponding to the detected proximity touch operation and proximity touch pattern may be displayed on a touch screen.

The output unit 150 generates visual, auditory, or tactile related outputs and thus, may include a display unit 151, a sound output module 152, an alarm unit 153, and a haptic module 154.

The display unit 151 displays (outputs) the information processed in the mobile terminal 100. For example, in the case of a call mode, the mobile terminal 100 displays a user interface (UI) or a graphic user interface (GUI) relating to a call. In the case of a video call mode or a capture mode, the mobile terminal 100 displays a captured or/and received image, UI or GUI.

The display unit 151 may include at least one of liquid crystal display (LCD), thin film transistor-liquid crystal display (TFT LCD), organic light-emitting diode (OLED), a flexible display, and a 3D display.

Among the displays, some displays may be configured with a transparent type or a light transmissive type to see the outside through them. These may be called a transparent display, and its representative example includes transparent OLED (TOLED). The rear structure of the display unit 151 may be also configured with a light transmissive structure. By such a structure, a user may see an object at the rear of a terminal body through an area that the display unit 151 of the terminal body occupies.

There may be at least two display units 151 according to the implementation type of the mobile terminal 100. For example, the mobile terminal 100 may include a plurality of display units, which are integrally disposed or spaced apart from each other at one surface, or are disposed at different surfaces.

The sound output module 152 may receive audio data from the wireless communication unit 110 or may output audio data stored in the memory 160 in a call signal receiving mode, a call mode, a recording mode, a voice recognizing mode, and a broadcast receiving mode. The sound outputting module 152 may output sound signals relating to functions performed in the mobile terminal 100 (for example, call signal reception sound or message reception sound). The sound outputting module 152 may include a receiver, a speaker, and a buzzer.

The alarm unit 153 outputs signals for notifying event occurrence of the mobile terminal 100. Examples of an event occurring in the mobile terminal 100 include call signal reception, message reception, key signal input, and touch input. The alarm unit 153 may output signals for notifying event occurrence in another format other than a video signal or an audio signal, for example, vibration. The video signal or audio signal may be outputted through the display unit 151 or the sound outputting module 152. Accordingly, the display unit 151 or the sound outing module 152 may be classified as part of the alarm unit 153.

The haptic module 154 may generate various haptic effects that a user can feel. A representative example of the haptic effect that the haptic module 154 generates includes vibration. The intensity and pattern of vibration that the haptic module 154 generates may be controllable. For example, different vibrations may be synthesized for output or may be sequentially outputted.

Besides vibration, the haptic module 154 may generate various haptic effects obtained by arrangement of pins vertically moving with respect to the contact skin, injection power or suction power of air through a nozzle or an intake, graze on the skin, electrode contact, stimulation of electrostatic force, and cold/warm sense reproduction using a device for suctioning or emitting heat.

The haptic module 154 may deliver haptic effects through direct contact and also may allow a user to feel haptic effects through muscle senses of the fingers or arms. There may be at least two haptic modules 154 according to a configuration aspect of the mobile terminal 100.

The memory 160 may store programs for an operation of the control unit 180 and also may temporarily store input/output data (for example, phone books, messages, still images, and videos). The memory 160 may store data relating to vibrations and sounds of various patterns outputted when the touch screen is touched for input.

The memory 160 may include at least one type of a storage medium selected from flash memory type memory, hard disk type memory, multimedia card micro type memory, card type memory (for example, SD or XD memory), Random Access Memory (RAM), Static Random Access Memory (SRAM), Read-Only Memory (ROM), Electrically Erasable Programmable Read-Only Memory (EEPROM), Programmable Read-Only Memory (PROM), magnetic memory, magnetic disk, and optical disk. The mobile terminal 100 may operate in linkage with a web storage performing a storage function of the memory 160 on the internet.

The interface unit 170 servers as a path to all external devices connected to the mobile terminal 100. The interface unit 170 receives data from external devices, receives and supplies power to each component of the mobile terminal 100, or transmits data in the mobile terminal 100 to external devices. For example, the interface unit 170 may include a wire/wireless headset port, an external charger port, a wire/wireless data port, a memory card port, a port connecting devices equipped with an identification module, an audio I/O port, a video I/O port, and an earphone port.

When the mobile terminal 100 is connected to an external cradle, the interface unit 170 may be a path through which power is supplied from the external cradle to the mobile terminal 100, or a path through which various command signals inputted from the external cradle by a user are delivered to the mobile terminal 100. The various command signals or power inputted from cradles may operate as signals for recognizing that the mobile terminal 100 is properly mounted on the cradles.

The control unit 180 controls overall operations of a mobile terminal. For example, the control unit 180 may control and process voice calls, data communications, and video calls. The control unit 180 may include a multimedia module 181 for playing multimedia. The multimedia module 181 may be embedded in or separated from the control unit 180.

The power supply unit 190 receives external power or internal power according to a control of the control unit 180, and supplies a power necessary for an operation of each component.

Various embodiments described herein may be implemented on a computer or similar device readable recording medium by using software, hardware or any combination thereof.

According to hardware implementation, the embodiments described herein may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electrical units for performing other functions. In some cases, such embodiments may be implemented by the control unit 180.

According to implementation of software, embodiments such as procedures or functions may be implemented with a separate software module for performing one function or operation. Software codes may be implemented by a software application written by a proper program language. The software codes may be stored in the memory 160 and may be executed by the control unit 180.

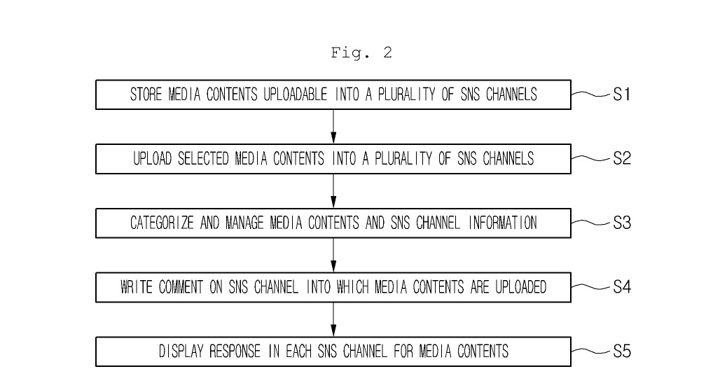

FIG. 2 is a flowchart illustrating an SNS contents integrated management method for a plurality of SNS channels according to an embodiment of the present invention.

Referring to FIG. 2, the control unit 180 may store in the memory 160 various media contents uploadable to a plurality of SNS channels in operation S1. Herein, the SNS channel may include Twitter, Facebook, LinkedIn, and LINE. However, the present invention is not limited thereto, and thus may be applied to various SNS channels.

The control unit 180 may upload arbitrary media contents, which are selected from media contents stored in the memory 160, into a plurality of SNS channels in operation S2. For this, the control unit 180 may run each SNS application for accessing each SNS channel. Accordingly, users access each SNS channel by using each SNS application running in the mobile terminal 100 to upload various media contents, thereby sharing various contents.

The control unit 180 may categorize and manage each media contents and information on each SNS channel having uploaded corresponding media contents S3.

For example, the control unit 180 may categorize the media contents uploaded to a plurality of channels by each SNS, each user, and each media contents in a background screen or a gallery screen for each thread of each SNS channel, and then may manage and display the categorized media contents.

Then, the control unit 180 may write an article on each SNS channel having uploaded corresponding media contents by each media contents in a predetermined menu screen in operation S4. For example, the control unit 180 may write a real-time comment on the media contents uploaded in an SNS channel.

Accordingly, users may access each SNS channel to post an article or write a comment on a posted article by using each SNS application installed in the mobile terminal 100.

Moreover, the control unit 180 may display response information on each SNS channel for corresponding media contents, on a predetermined menu screen in operation S5. For example, the control unit 180 may display on a screen a response on the media contents or comment uploaded in a corresponding SNS channel. Herein, the designated menu screen may be a gallery screen or a background screen.

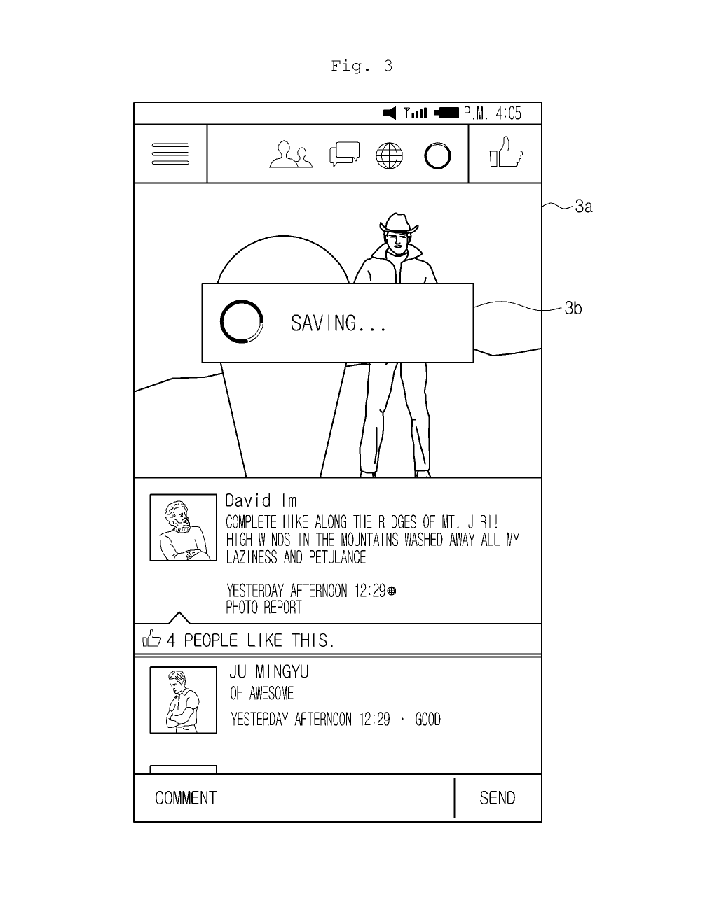

FIGS. 3 to 10 are screen views illustrating an SNS contents integrated management method for a plurality of SNS channels according to an embodiment of the present invention.

Referring to FIG. 3, the control unit 180 may store in the memory 160 media contents selected from the media SNS contents uploaded into the plurality of SNS channels, and then may manage the stored media contents. For example, the control unit 180 may display a thread screen 3a of an arbitrary SNS channel. The control unit 180 may select arbitrary media contents uploaded in the SNS channel of Facebook and then may store them in the memory 160. Accordingly, a save operation may be performed on a thread including corresponding media contents. Accordingly, a state message 3b notifying saving in progress may be displayed.

At this point, the control unit 180 may store in the memory 160 SNS contents added to the selected corresponding media contents and then may manage them. Accordingly, comments added to the corresponding media contents may be stored in the memory 160.

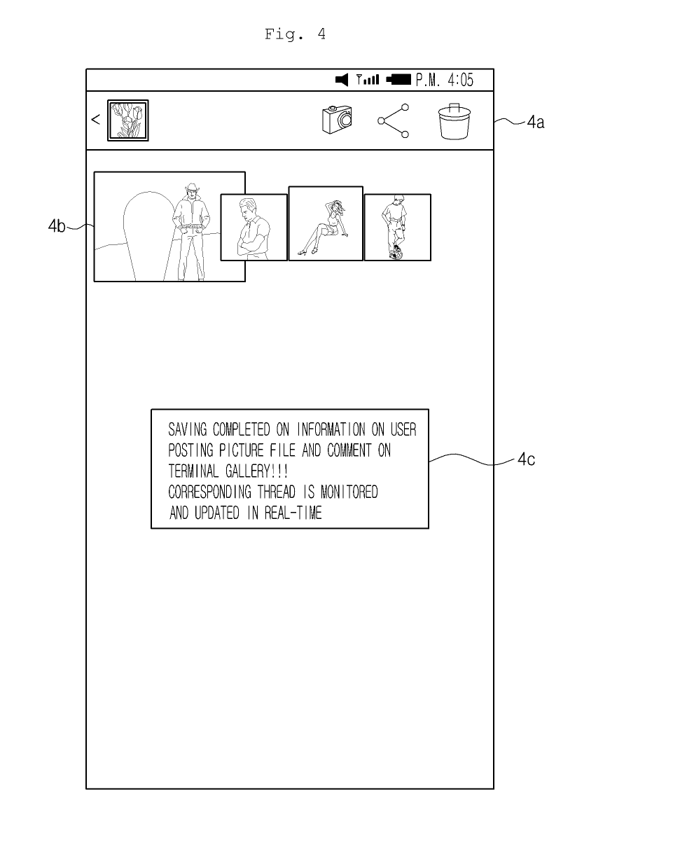

Referring to FIG. 4, the control unit 180 may store a thread of corresponding media contents in a predetermined menu screen. For example, the control unit 180 may store information on a user posting a picture file 4b and a comment on a gallery screen 4a. The control unit 180 may monitor the media contents stored in the memory 160 in real-time. Likewise, the control unit 180 may monitor the SNS contents added to the corresponding media contents in real-time. The control unit 180 may perform update when there is changed information through real-time monitoring. The control unit 180 may display a notification pop-up 4c for monitoring and update.

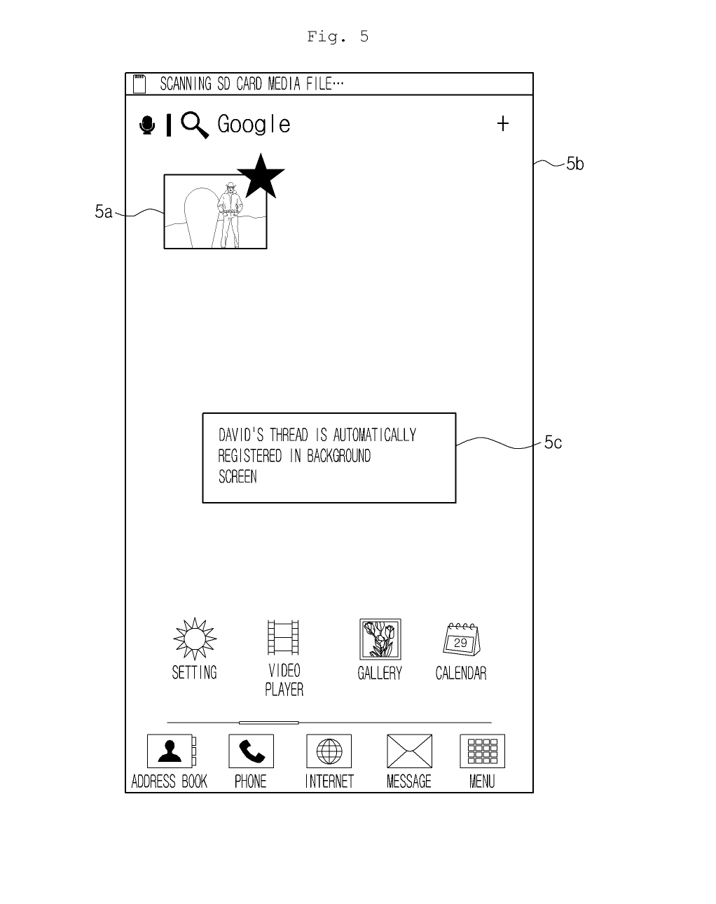

Referring to FIG. 5, the control unit 180 may register at least one object 5a for real-time monitoring in a predetermined menu screen 5b and then may display it.

This object is to display the thread of a corresponding SNS channel having uploaded media contents. For example, the control unit 180 may display an object for displaying the thread of an arbitrary SNS channel as a thumbnail on a background screen.

The control unit 180 may display a notification pop-up 5c for notifying a thread registration for the background screen.

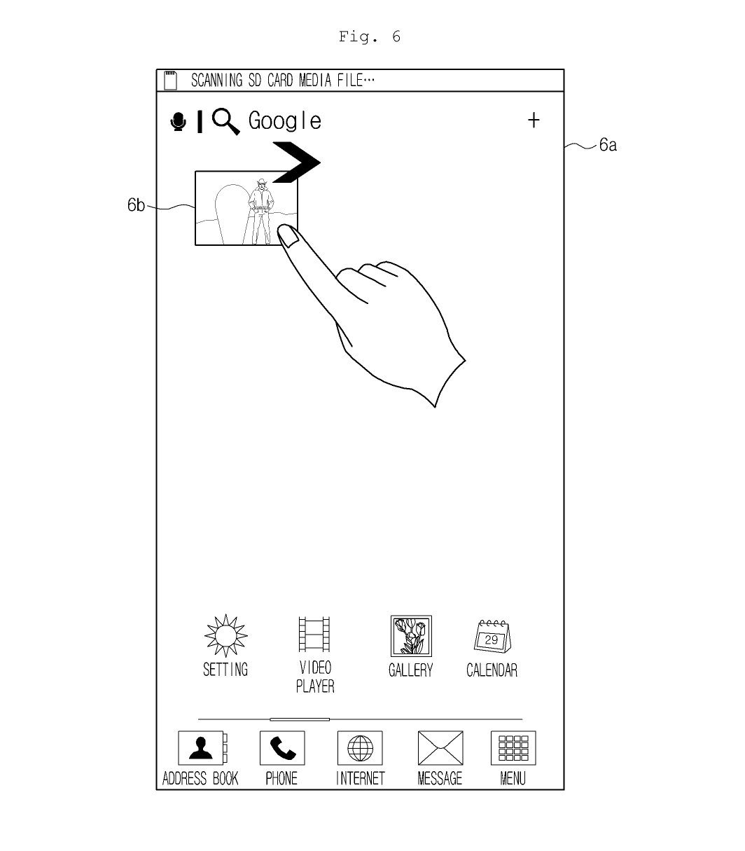

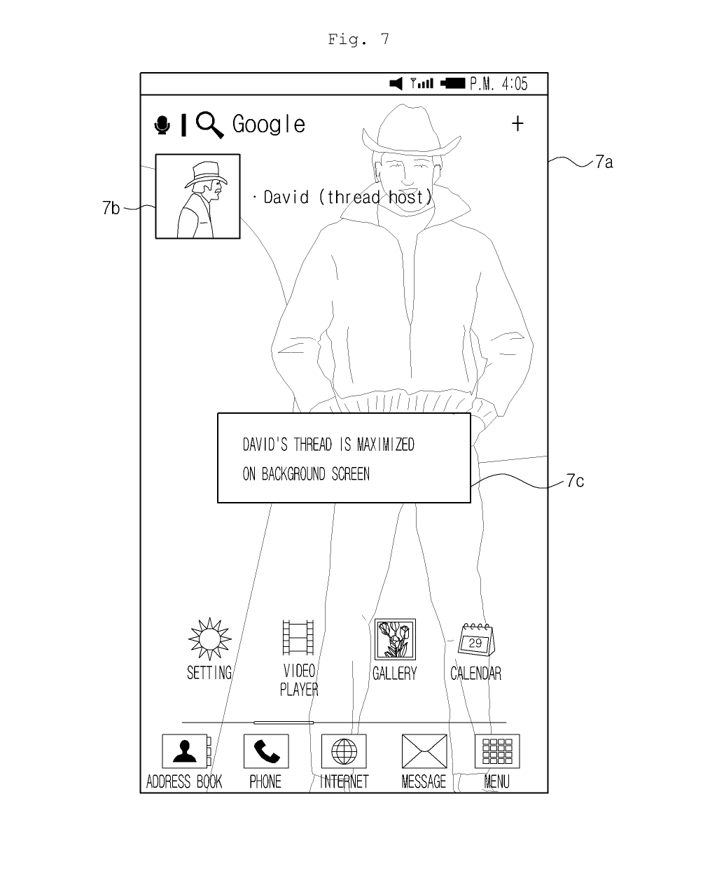

Referring to FIGS. 6 and 7, the control unit 180 may maximize and display corresponding media contents on a background screen 7a when an arbitrary thumbnail 6a displayed on the background screen 6a is clicked. The control unit 180 may display an object 7b notifying thread host information of corresponding media contents. The control unit 180 may display a notification pop-up 7c for notifying the thread maximization for the background screen.

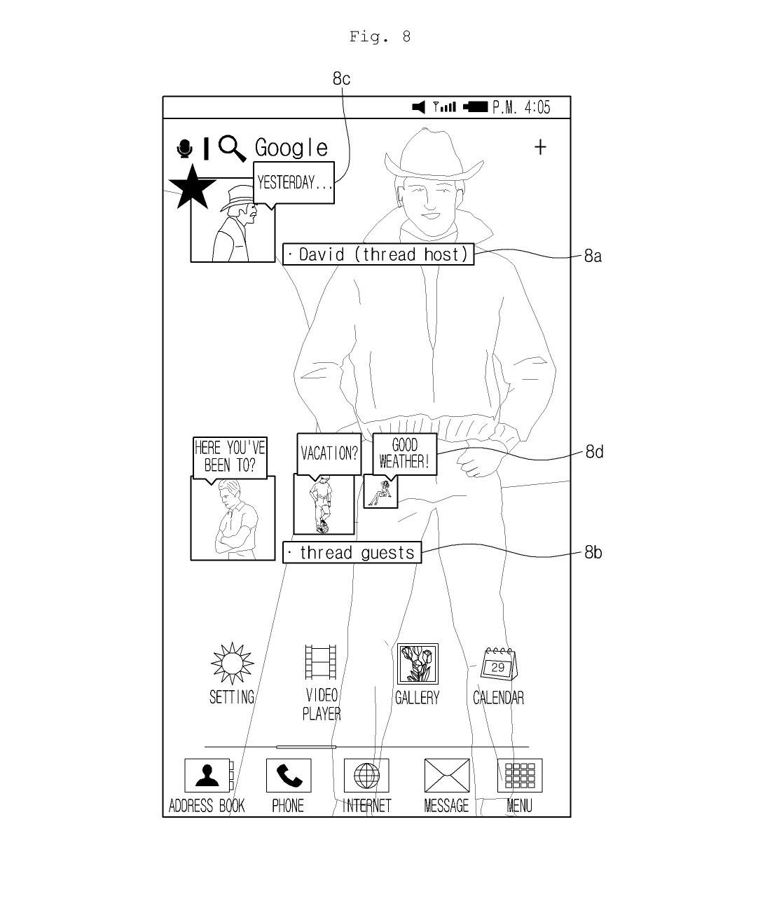

Referring to FIG. 8, the control unit 180 may display thread host information 8a for a corresponding SNS channel while maximizing and displaying corresponding media contents on the background screen.

A thread host refers to a user who uploads arbitrary media contents to an arbitrary SNS channel and generates an arbitrary thread. Accordingly, thread host information may include an image that identifies a corresponding thread host.

The control unit 180 may display thread guest information 8c for an arbitrary channel on the background screen. A thread guest refers to at least one user who writes a comment on corresponding media contents. Accordingly, the thread guest information 8b may include an image that identifies a corresponding thread guest.

The thread host information 8a may include a speech bubble 8c. The speech bubble 8c included in the thread host information 8a may be displayed with a text that a thread host writes.

In the same manner, the thread guest information 8b may include a speech bubble 8d. The speech bubble 8d in the thread guest information 8b may be displayed with a comment that a thread guest writes on a corresponding thread.

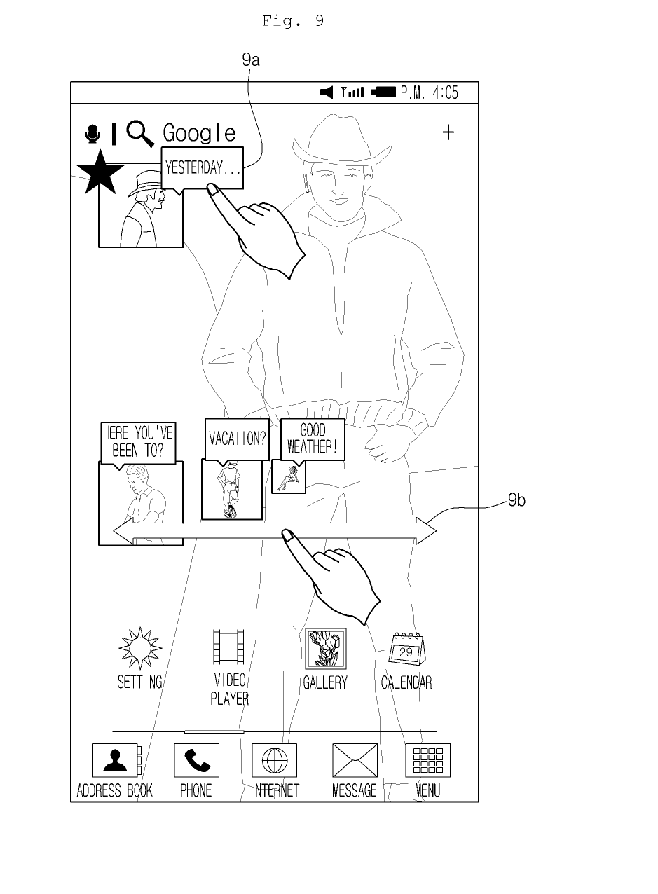

Referring to FIG. 9, the control unit 180 may perform a comment write mode when there is a click input on the speech bubble 9a. For example, the control unit 180 may execute a write or comment input mode on a corresponding speech bubble once a speech mode on thread host information or thread guest information is clicked.

Additionally, the control unit 180 may move a plurality of thread guest information to the left or right in the screen and then may sequentially display them when there is a left and right flicking for thread guest information. The thread guest information may include comments through each speech bubble.

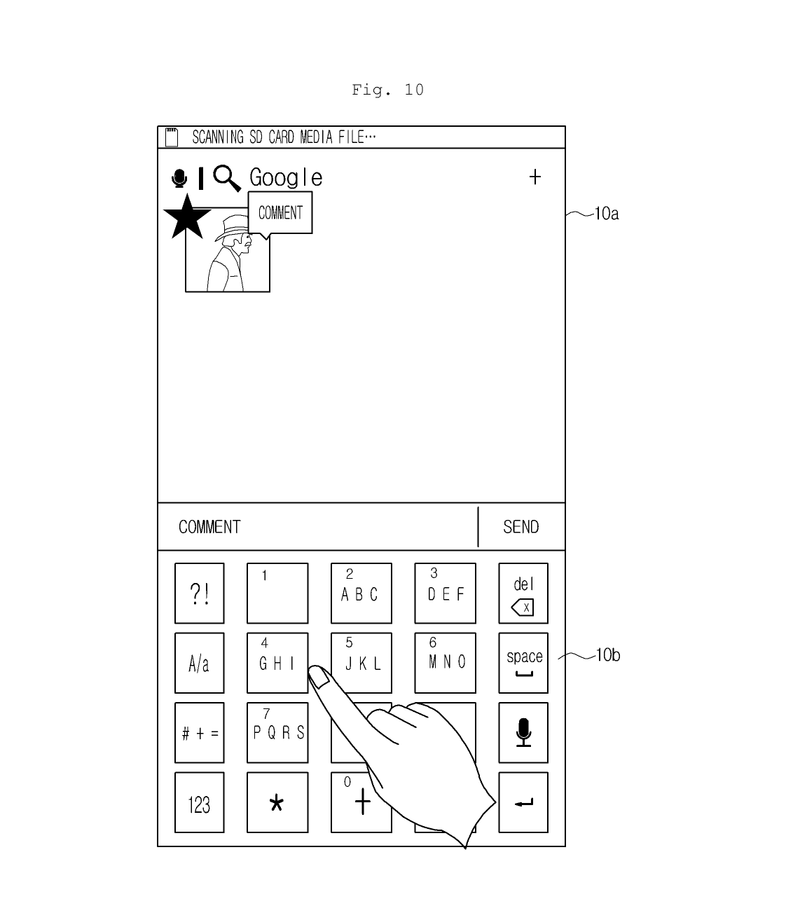

Referring to FIG. 10, the control unit 180 executes a write or comment input mode on a corresponding speech bubble once a speech bubble of thread host information is clicked, and then, displays a writing screen 10a and a soft keypad for inputting writing, on a screen.

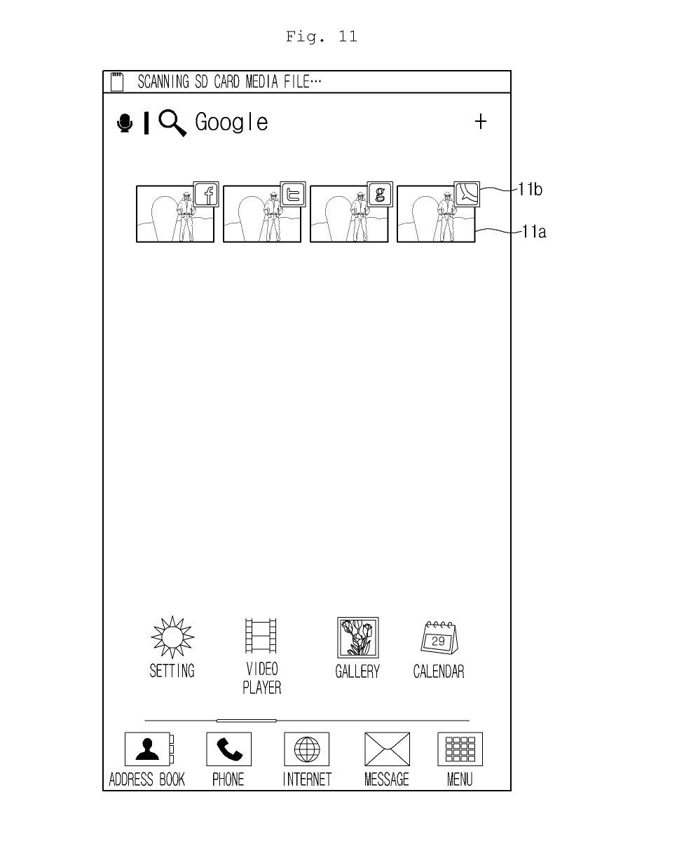

FIG. 11 is a view illustrating an SNS contents integrated management method for a plurality of SNS channels according to another embodiment of the present invention.

Referring to FIG. 11, the control unit 180 may register in a predetermined menu screen a plurality of objects 11a for displaying threads of each SNS channel where media contents are uploaded by each SNS channel and then, may display them.

Here, the control unit 180 may add to the object 11a a plurality of identification information 11b displaying each SNS channel where corresponding media contents are uploaded, and then, may display the object 11a.

The control unit 180 may display a thread of a corresponding SNS channel once one of the plurality of identification information is clicked.

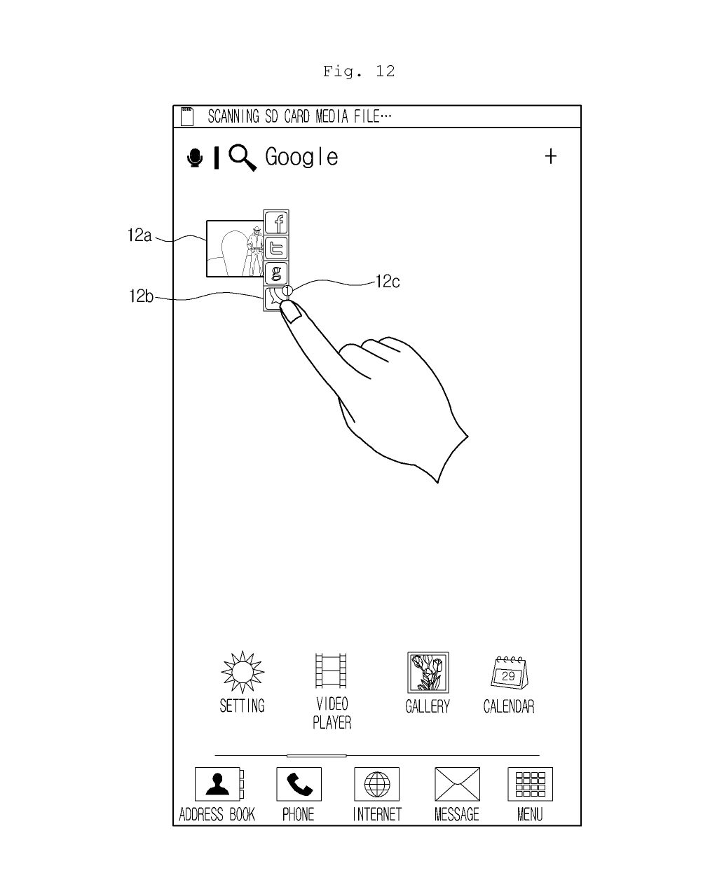

FIG. 12 is a screen view illustrating an SNS contents integrated management method for a plurality of SNS channels according to another embodiment of the present invention.

Referring to FIG. 12, the control unit 180 may register in a predetermined menu screen a corresponding object 12a and identification information 12b for displaying threads of each SNS channel where media contents are uploaded, and then, may display them.

Here, the control unit 180 may add to one object a plurality of identification information 12b displaying each SNS channel where corresponding media contents are uploaded, and then, may display it. Information 12c indicating the number of unchecked comments for a corresponding SNS channel may be displayed in the plurality of identification information 12b.

The control unit 180 may display a thread of a corresponding SNS channel once one of the plurality of identification information is clicked.

In relation to the modified embodiment of FIGS. 11 and 12, the control unit 180 displays corresponding media contents on a screen when one media contents is uploaded to several SNS channels, and then, displays each SNS channel when a user flicks an upper end region of the screen to the left or right. Additionally, the control unit 180 may display the identification icons of thread guests who write comments on corresponding media contents by a predetermined number once flicking is made at a lower end of the screen.

The control unit 180 executes a corresponding SNS application once an arbitrary identification icon is clicked, and then, accesses a corresponding channel application server to display the screen of corresponding contents.

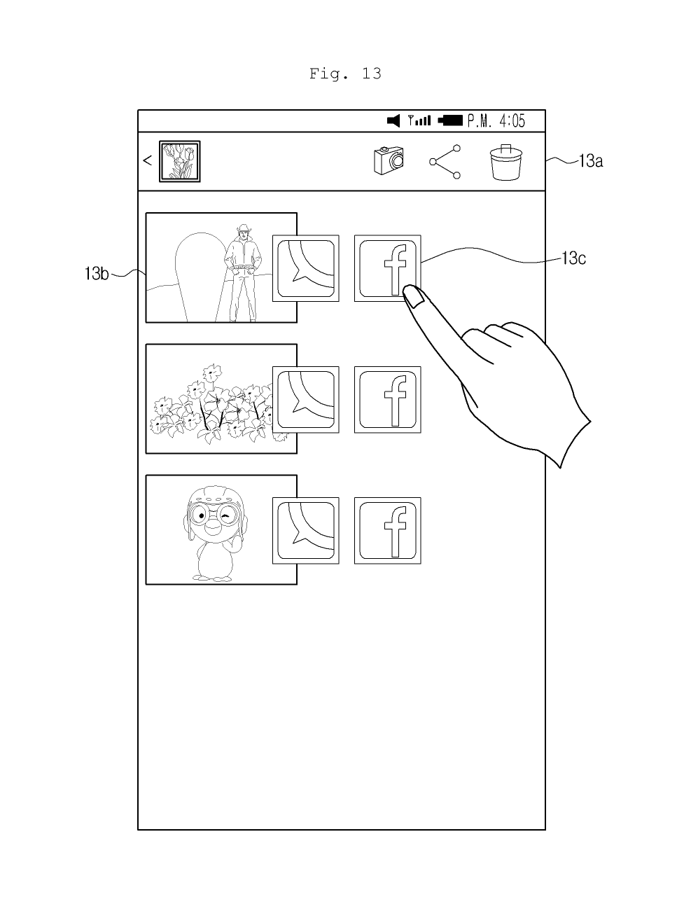

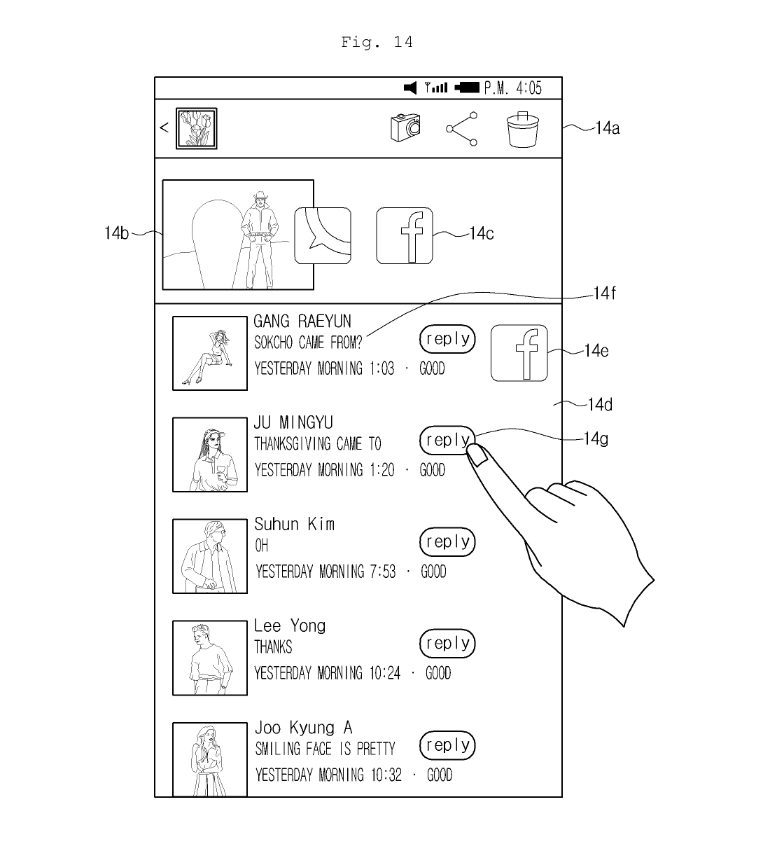

FIGS. 13 and 14 are screen views illustrating an SNS contents integrated management method for a plurality of SNS channels according to another embodiment of the present invention.

Referring to FIG. 13, the control unit 180 may display on a gallery screen media contents uploaded into each SNS channel among the media contents stored in the memory 160 in addition to a plurality of objects for displaying threads of each SNS channel where corresponding media contents are uploaded.

For this, the control unit 180 may display each media contents 13b on a gallery screen 13a and also may display a plurality of objects 13c for displaying threads of each SNS channel where corresponding media contents are uploaded by each SNS channel with respect to corresponding media contents. Here, the control unit 180 may display on each object a plurality of identification information for displaying each SNS channel where corresponding media contents are uploaded.

The control unit 180 may display a thread of a corresponding SNS channel once one of the plurality of identification information is clicked.

Referring to FIG. 14, the control unit 180 may display a thread screen 14d of a corresponding SNS channel once SNS channel identification information 14c for arbitrary media contents 14b displayed on the gallery screen 14a is clicked. A thread screen 14d may include identification information 14e of an SNS channel where corresponding media contents are uploaded, comments 14f generated for corresponding media contents, and an icon 14g through which an additional comment is posted with respect to a corresponding comment.

The control unit 180 may execute a mode for writing a comment once an icon for posting an additional comment is clicked in the thread screen 14d.

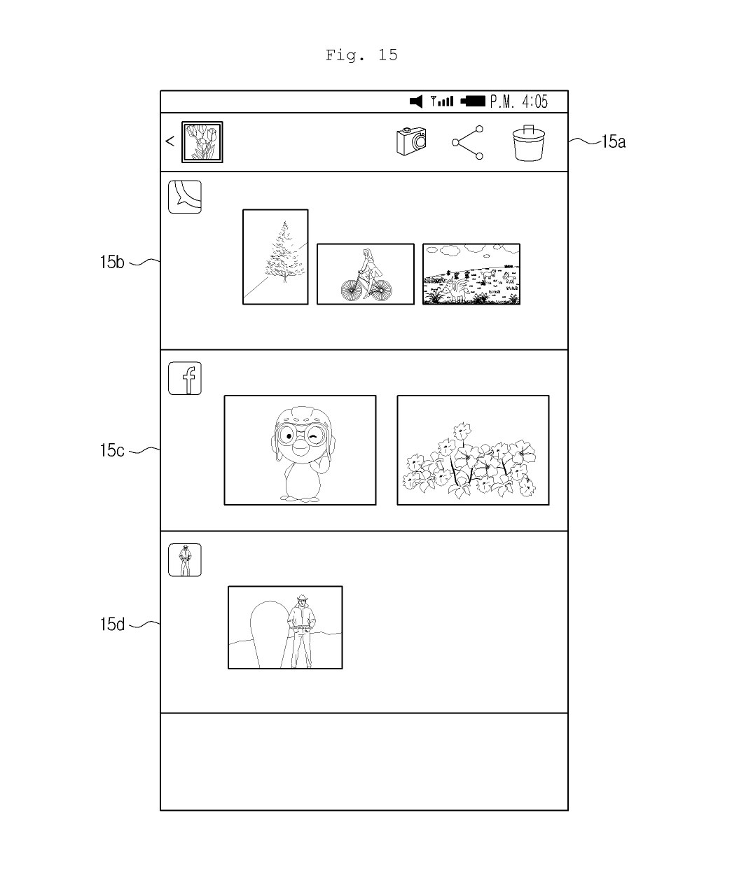

FIG. 15 is a view illustrating an SNS contents integrated management method for a plurality of SNS channels according to another embodiment of the present invention.

Referring to FIG. 15, the control unit 180 may categorize and manage each media contents and information on each SNS channel having uploaded corresponding media contents in a gallery screen 15a.

For example, the control unit 180 may categorize the media contents uploaded to a plurality of SNS channels by each SNS 15b or 15c and each user 15d for a thread of each SNS channel, and then, may display them on a gallery screen. The control unit 180 may manage uploading, comment posting, and comment checking for each media contents displayed by the categorized each SNS and each user in real-time on the gallery screen.

Besides that, the control unit 180 may align media contents uploaded to each SNS channel by each latest contents and each importance, and then, may display them on a screen.

The control unit 180 may notify into which SNS channel corresponding contents are uploaded by displaying an icon for each SNS channel on each media contents.

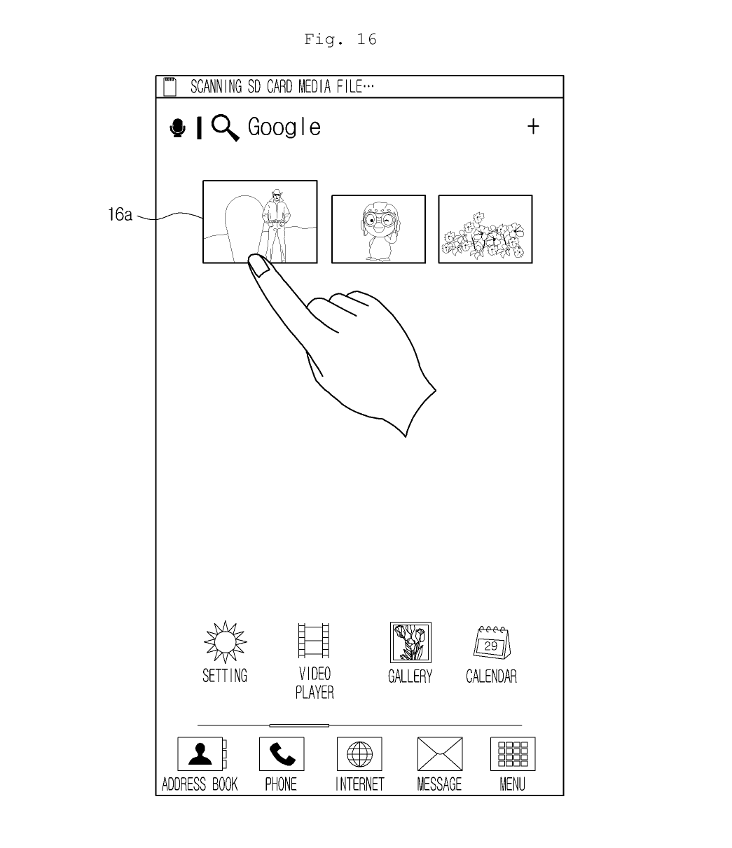

FIGS. 16 to 18 are screen views illustrating an SNS contents integrated management method for a plurality of SNS channels according to another embodiment of the present invention.

Referring to FIG. 16, the control unit 180 may install an object of a thumbnail format on a background screen through selection of favorites concepts. Accordingly, the control unit 180 may register at least one object 16a for real-time update in a background screen, and then, may display it. This object 16a is to display the thread of a corresponding SNS channel having uploaded media contents. The control unit 180 may perform a real-time update on stored media contents and SNS contents by using the object 16a.

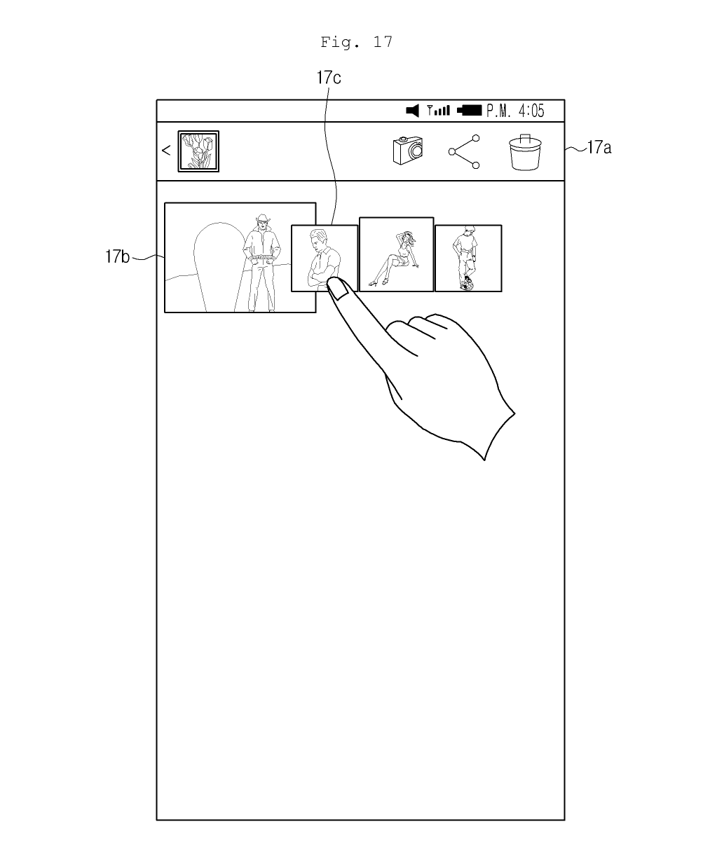

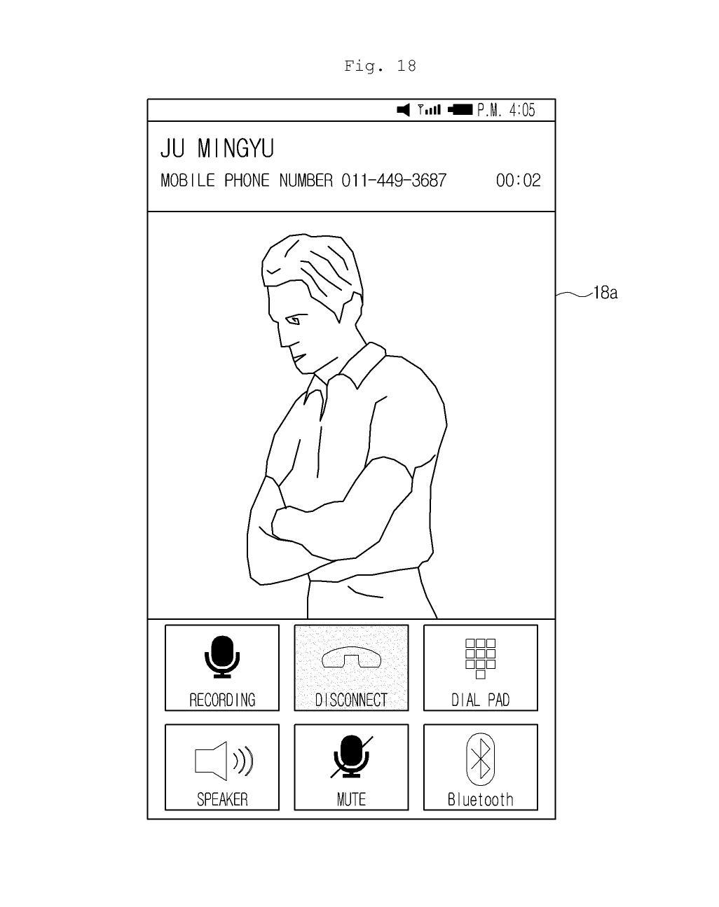

Referring to FIGS. 17 and 18, the control unit 180 may attempt to make a phone call to a contact number pre-linked to corresponding thread guest information 18a once arbitrary thread guest information 17c displayed for an arbitrary media contents thread 17b is clicked in a gallery screen 17a. For example, the control unit 180 may attempt to make a phone call on the basis of a contact number.

According to the present invention, in a terminal, contents or comments uploaded using several SNS channels may be categorized by each SNS, each user, and each contents in a predetermined menu screen such as a background screen or a gallery for each thread and may be managed.

Accordingly, a user may confirm on which SNS channel a picture registered in a gallery by the user is posted and may recognize a current updated item.

According to the present invention, in a terminal, without executing each SNS application, a comment is posted on each SNS channel in real-time or a response according thereto is displayed in real-time in a predetermined menu screen such as a background screen or a gallery. Therefore, a plurality of SNS channels may be effectively managed.

According to the present invention, a thread that a user is interested is selected from various threads uploaded in a plurality of SNS channels and stored in a terminal, so that threads may be categorized and managed.

The invention can also be embodied as computer readable codes on a computer readable recording medium. Examples of the computer readable recording medium include read-only memory (ROM), random-access memory (RAM), CD-ROMs, magnetic tapes, floppy disks, and optical data storage devices, and carrier waves (such as data transmission through the Internet).

The mobile terminal may, however, be embodied in many different forms and should not be construed as being limited to the embodiments set forth herein; rather, these embodiments are provided so that this disclosure will be thorough and complete, and will fully convey the concept of the invention to those skilled in the art.

Although embodiments have been described with reference to a number of illustrative embodiments thereof, it should be understood that numerous other modifications and embodiments can be devised by those skilled in the art that will fall within the spirit and scope of the principles of this disclosure. Thus, it is intended that the present invention covers the modifications and variations of this invention provided they come within the scope of the appended claims and their equivalents.

What is claimed is:

1. A terminal comprising:
a memory storing media contents uploadable into a plurality of SNS channels; and
a control unit updating arbitrary media contents stored in the memory into the plurality of SNS channels, categorizing each media contents and information on each SNS channel into which corresponding media contents are uploaded and integrally managing the categorized media contents and information, writing a comment on an SNS channel into which each corresponding media contents are uploaded by each media contents on a designated menu screen, and displaying a response to corresponding media contents.

2. The terminal according to claim 1, wherein the control unit categorizes the media contents uploaded into the plurality of SNS channels by each SNS, each user, or each media contents in a background or a gallery screen by a thread of each SNS channel, and manages and displays the categorized media contents.

3. The terminal according to claim 1, wherein the control unit displays a real-time comment on the media contents uploaded into the SNS channel and a response to the media contents or the comment, on a screen in real-time.

4. The terminal according to claim 1, wherein the control unit stores media contents selected from media SNS contents uploaded into the plurality of SNS channels and SNS contents added to corresponding media contents in the memory and manages the stored media contents and SNS contents.

5. The terminal according to claim 4, wherein the control unit performs a real-time monitoring or a real-time update on the stored media contents and SNS contents.

6. The terminal according to claim 5, wherein the control unit registers in a predetermined menu screen an object for displaying a thread of a corresponding SNS channel into which the media contents are uploaded in order for the real-time monitoring or the real-time update, and displays the registered object.

7. The terminal according to claim 6, wherein the control unit displays the object for displaying the thread of the SNS channel as a thumbnail on a background screen.

8. The terminal according to claim 7, wherein the control unit maximizes corresponding media contents and displays the maximized corresponding media contents on a background screen once the thumbnail is clicked.

9. The terminal according to claim 8, wherein the control unit displays information on a thread host uploading corresponding media contents and at least one information on a thread guest generating a comment on corresponding media contents, on the background screen.

10. The terminal according to claim 9, wherein the thread host information and the at last one thread guest information comprise a speech bubble displaying a comment generated on a corresponding thread.

11. The terminal according to claim 10, wherein the control unit executes a comment input mode on a corresponding speech bubble once the speech bubble is clicked.

12. The terminal according to claim 9, wherein the control unit attempts to make a contact to a connect number linked to corresponding thread guest information once the thread guest information is clicked.

13. The terminal according to claim 12, wherein the control unit attempts to make a phone call on the basis of the contact number.

14. The terminal according to claim 9, wherein the control unit moves and displays the at least one thread guest information displayed on the background screen in correspondence to a left and right flicking input.

15. The terminal according to claim 7, wherein the control unit registers a plurality of objects for displaying threads of each SNS channel into which the media contents are uploaded by each SNS channel, in a predetermined menu screen and displays the registered objects.

16. The terminal according to claim 7, wherein the control unit adds to the object a plurality of identification information displaying each SNS channel into which corresponding media contents are uploaded and displays the object.

17. The terminal according to claim 16, wherein the control unit displays a thread of a corresponding SNS channel once one of the plurality of identification information is clicked.

18. An SNS contents integrated management method for a plurality of SNS channels, the method comprising:
storing media contents uploadable to a plurality of SNS channels in the memory;
uploading arbitrary media contents stored in the memory into the plurality of SNS channels;
categorizing each media contents and each SNS channel information into which corresponding media contents are uploaded and integrally managing the categorized media contents and SNS channel information; and
writing a comment on an SNS channel into which corresponding media contents are uploaded by each media contents on a designated menu screen, and displaying a response to corresponding media contents.

19. The method according to claim 18, further comprising storing media contents selected from media contents uploaded into the plurality of SNS channels and SNS contents added to corresponding media contents in the memory and managing the media contents and SNS contents.

20. The method according to claim 19, further comprising performing a real-time monitoring on the stored media contents and SNS contents.
